(19) United States
(12) Patent Application Publication
(10) Pub. No.: US 2014/0153283 A1
(43) Pub. Date: Jun. 5, 2014

(54) BACKLIGHT MODULES AND LIQUID DISPLAY DEVICES WITH THE SAME

(71) Applicant: Shenzhen China Star Optoelectronics Technology Co. Ltd., Shenzhen, Guangdong (CN)

(72) Inventor: Jiahe Cheng, Shenzhen (CN)

(73) Assignee: Shenzhen China Star Optoelectronics Technology Co., Ltd., Shenzhen, Guangdong (CN)

(21) Appl. No.: 13/699,696

(22) PCT Filed: Oct. 12, 2012
(86) PCT No.: PCT/CN2012/082864

§ 371 Date: Nov. 23, 2012

(30) Foreign Application Priority Data
Sep. 28, 2012 (CN) 201210366717.9

(51) Int. Cl. F21V 8/00

(52) U.S. Cl. CPC G02B 6/0031
USPC 362/612; 362/611

(57) ABSTRACT

A backlight module includes a light guiding plate and a light source is disclosed.

The light source includes a light body and a mask. The mask surrounds a rim of the light guiding plate to from a cavity with at least one opening. The light body is fixed on the opening and a light emitting surface of the light body faces toward an internal of the cavity. In addition, a liquid crystal display includes the above backlight module is disclosed. The backlight module and the liquid crystal display include a reduced amount of LEDs and circuit boards so that the cost and the power consumption are reduced.

### BACKGROUND OF THE INVENTION

This application claims priority to China Patent Application No. 201210366717.9 filed on Sep. 28, 2012 entitled, BACKLIGHT MODULES AND LIQUID CRYSTAL DEVICES WITH THE SAME, all of the disclosures of which are incorporated herein by reference in their entirety.

1. Field of the Invenetion

Embodiments of the present disclosure relate to display technology, and more particularly to backlight modules and liquid display devices with the same.

2. Discussion of the Related Art

Liquid crystal devices include display modules to display images. Light sources include Cold Cathode Fluorescent Lamp (CCFL) and Light Emitting Diode (LED). Currently, more and more liquid crystal devices adopt the LED light source for the reason that the brightness is high and the power consumption is low.

FIG. 5 is a partial cross-sectional view of a typical backlight module. Generally, a plurality of LEDs is fixed on the printed circuit board (PCB) or a metal core PCB (MCPCB) to form a light bar 9. The light bar 9 is then fixed on a side of a backlight module. However, the cost of the backlight module is high as a great deal of MCPCBs and LEDs are used. In addition, the power consumption of the backlight module is also high.

### SUMMARY

The object of the claimed invention is to provide a backlight module and a liquid crystal device with a reduced amount of LEDs and PCBs so that the cost and the power consumption are reduced.

In one aspect, a backlight module includes a light guiding plate and a light source. The light source includes a light body and a mask. The mask surrounds a rim of the light guiding plate to from a cavity with at least one opening. The light body is fixed on the opening and a light emitting surface of the light body faces toward an internal of the cavity.

Wherein a reflective layer is arranged on an internal wall of the cavity.

Wherein a plurality of reflective points are arranged on the reflective layers.

Wherein the mask is a bending plate with U-shaped cross section, and the opening is arranged on two sides of the bending portions of the bending plate.

Wherein the light body includes printed circuit boards (PCBs) and LEDs encapsulated on the PCBs in a circular form so that light emitting surfaces of the LEDs are hemisphere.

Wherein the cavity includes two openings, the light from the LEDs are toward the internal of the cavity, and are reflected from the internal wall of the cavity into the light guiding plate.

Wherein at least one clasp is arranged on one edge of the bending plate.

Wherein at least one slot is arranged on a side surface of the light guiding plate in accordance with the clasp so that the mask is assembled with the light guiding plate by engaging the clasp and the slot.

Wherein the bending plate is formed by applying a punch-shaping process to a metallic sheet.

In another aspect, a liquid crystal device includes a backlight module. The backlight module includes a light guiding plate and a light source. The light source includes a light body and a mask. The mask surrounds a rim of the light guiding plate to from a cavity with at least one opening. The light body is fixed on the opening and a light emitting surface of the light body faces toward an internal of the cavity.

Wherein a reflective layer is arranged on an internal wall of the cavity.

Wherein a plurality of reflective points are arranged on the reflective layers.

Wherein the mask is a bending plate with U-shaped cross section, and the opening is arranged on two sides of the bending portions of the bending plate.

Wherein the light body includes printed circuit boards (PCBs) and LEDs encapsulated on the PCBs in a circular form so that light emitting surfaces of the LEDs are hemisphere.

Wherein the cavity includes two openings, the light from the LEDs are toward the internal of the cavity, and are reflected from the internal wall of the cavity into the light guiding plate.

Wherein at least one clasp is arranged on one edge of the bending plate.

Wherein at least one slot is arranged on a side surface of the light guiding plate in accordance with the clasp so that the mask is assembled with the light guiding plate by engaging the clasp and the slot.

Wherein the bending plate is formed by applying a punch-shaping process to a metallic sheet.

### BRIEF DESCRIPTION OF THE DRAWINGS

FIG. 1 is a side view of the backlight module in accordance with one embodiment.

FIG. 2 is a cross-sectional view of the mask and the light guiding plate of the backlight module in accordance with one embodiment.

FIG. 3 is a perspective view of the assembled backlight module in accordance with one embodiment.

FIG. 4 is a partial cross-sectional view of the assembled backlight module in accordance with one embodiment.

FIG. 5 is a partial cross-sectional view of a typical backlight module.

### DETAILED DESCRIPTION OF THE EMBODIMENTS

Embodiments of the invention will now be described more fully hereinafter with reference to the accompanying drawings, in which embodiments of the invention are shown.

As shown in FIGS. 1 to 4, a backlight module includes a light source and a light guiding plate 3. The light source includes a light body 1 and a mask 2. The mask 2 surrounds a rim of the light guiding plate 3 to form a cavity 4 with at least one opening 21.

The light body 1 is fixed on the opening 21. A light emitting surface of the light body 1 faces toward an internal of the cavity 4.

The light body 1 includes one PCB and LEDs arranged on the PCB. In the embodiment, the PCB is a MCPCB 11. The LEDs 12 are fixed on the MCPCB 11. In addition, the LEDs 12 are encapsulated in a circular form so that the light emitting surfaces of the LEDs 12 are hemisphere. As such, the lights may be emitted at a larger angle to improve the light efficiency.

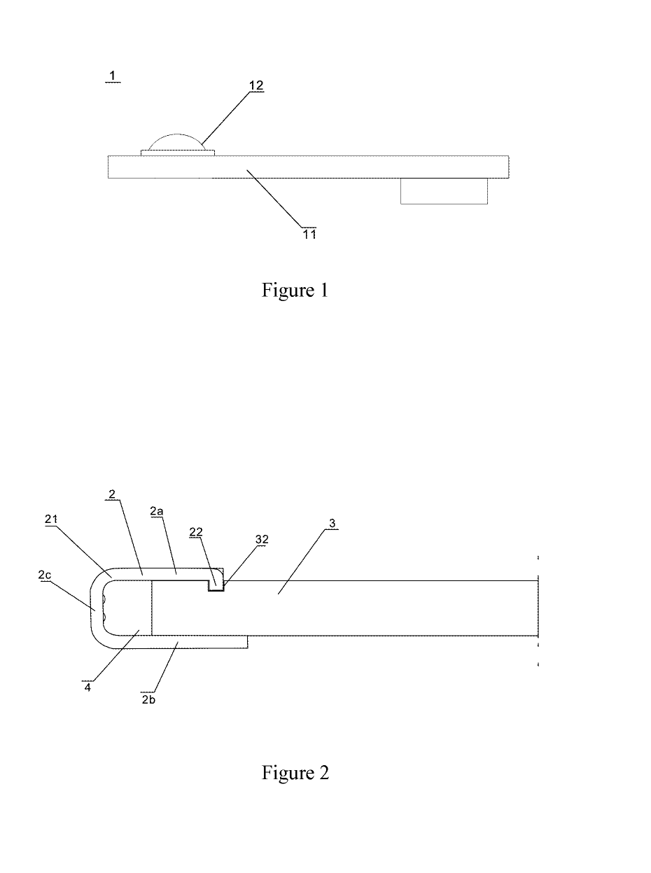

In the embodiment, the mask 2 is a bending plate with U-shaped cross section. The bending plate includes a top 2a, a bottom 2b and a bending portion 2c between the top 2a and the bottom 2b as shown in FIG. 2. The mask 2 is formed by bending a sheet twice. The top 2a and the bottom 2b are substantially parallel to each other. The opening 21 is arranged on two sides of the bending portion 2c.

The length of the top 2a is slightly smaller than that of the bottom 2b so as to facilitate the assembly. The distance between the top 2a and the bottom 2b is substantially the same with the thickness of the light guiding plate 3.

It is to be understood that as the mask 2 is bended, the lights from the LEDs 12 may be reflected by an internal wall of the mask 2. Thus, the light efficiency is enhanced and the number of the LEDs may be reduced. On the other hand, the strength of the mask 2 is increased.

In the embodiment, the mask 2 is formed by applying a punch-shaping process to a metallic sheet. The metallic sheet may be an alumni sheet.

In one embodiment, the light guiding plate 3 is clasped by the top 2 and the bottom 2b of the mask 2. Specifically, two clasps 22 are arranged on one edge of the top 2a of the mask 2. Two slots 32 are arranged on a side surface of the light guiding plate 3 in accordance with the clasps 22. The bending plate is assembled with the light guiding plate 3 by engaging the clasps 22 with the slots 32.

The mask 2 may connect to the light guiding plate 3 by other connecting methods as long as the cavity 4 is formed when one edge of the light guiding plate 3 is surrounded by the mask 2.

The light guiding plate 3 connects with edges of the mask 2 so that the cavity 4 is formed in the internal of the mask 2. In the embodiment, the cavity 4 is for reflecting the lights into the light guiding plate 3.

In the embodiment, the opening 21 is arranged on two sides of the bending portion 2c. In other embodiments, the opening 21 may be arranged on other positions of the cavity 4.

As described above, the LEDs 12 face toward the cavity 4 and the MCPCB 11 is fixed on the opening 21. As such, the lights from the LEDs 12 are toward the internal of the cavity 4, and are reflected from an internal wall of the cavity 4 into the light guiding plate 3.

In the embodiment, the light body 1 includes two MCPCB 11 and two LEDs 12 respectively arranged on one of the MCPCB 11. The structures of the two MCPCB 11 are substantially the same. The two MCPCBs 11 are fixed on two opposite sides of the opening 21 of the cavity 4, and the light emitting surfaces of the LEDs 12 face toward the internal of the cavity 4.

It is to be understood that backlight module may include a plurality of light bodies 1. For example, the backlight module includes two light bodies 1, and thus four MCPCB 11 are respectively arranged on four corners of the light guiding plate 3.

Referring to FIG. 4, the internal wall of the cavity 4 includes a reflective layer 41 for reflecting the lights from the LEDs 12 toward the light guiding plate 3. Such arrangement may also be applied to large-scale backlight modules, such as 20 inches.

Further, reflective points may also be arranged on the reflective layers in large-scale LCD manufacturing. The reflective points not only have the same effect as the reflective layer, but also may control the density of the reflected lights by changing the dimensions or the arrangement of the reflective points. Thus, the internal wall of the cavity 4 may include the reflective layer 41 and the reflective points 42 arranged on the reflective layer 41.

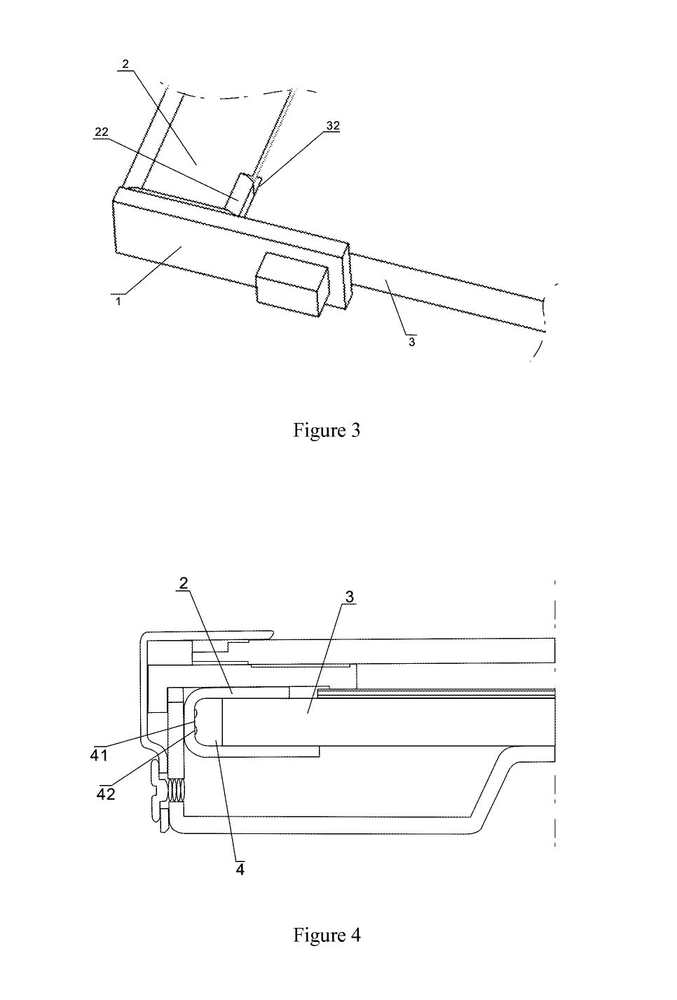

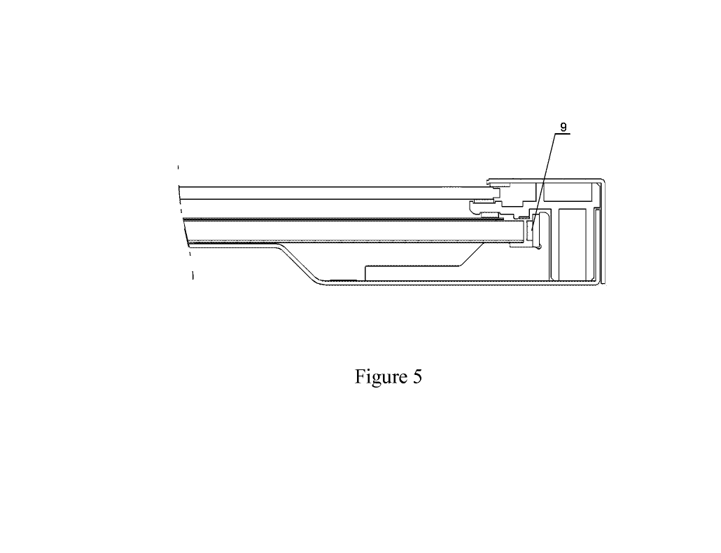

During assembly, as shown in FIG. 3, the mask 2 and the light guiding plate 3 are assembled together first, and are then fixed on a back plane (not shown) of the backlight module. Afterward, the light body 1 is fixed on the opening 21, and the light emitting surfaces of the LEDs 12 face toward the cavity 4.

The lights emitted from the light emitting surfaces of the LEDs 12 are reflected from the reflective layer 41 and the reflective points 42 of the cavity 4 toward the light guiding plate 3.

In one embodiment, a liquid crystal device includes the backlight module described above.

In view of the above, the mask surrounds the rim of the light guiding plate to form the cavity. The LEDs are fixed on the opening of the cavity. The lights from the LEDs are reflected by the internal wall of the cavity into the light guiding plate. The light source may include fewer LEDs than typical ones. As such, the LEDs and circuit boards of the backlight module are reduced so that the cost and the power consumption are also reduced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module, comprising:
a light guiding plate; and
a light source comprises a light body and a mask, the mask surrounds a rim of the light guiding plate to from a cavity with at least one opening, the light body is fixed on the opening and a light emitting surface of the light body faces toward an internal of the cavity.

2. The backlight module as claimed in claim 1, wherein a reflective layer is arranged on an internal wall of the cavity.

3. The backlight module as claimed in claim 2, wherein a plurality of reflective points are arranged on the reflective layers.

4. The backlight module as claimed in claim 1, wherein the mask is a bending plate with U-shaped cross section, and the opening is arranged on two sides of the bending portions of the bending plate.

5. The backlight module as claimed in claim 4, wherein the light body comprises printed circuit boards (PCBs) and LEDs encapsulated on the PCBs in a circular form so that light emitting surfaces of the LEDs are hemisphere.

6. The backlight module as claimed in claim 5, wherein the cavity comprises two openings, the light from the LEDs are toward the internal of the cavity, and are reflected from the internal wall of the cavity into the light guiding plate.

7. The backlight module as claimed in claim 5, wherein at least one clasp is arranged on one edge of the bending plate.

8. The backlight module as claimed in claim 7, wherein at least one slot is arranged on a side surface of the light guiding plate in accordance with the clasp so that the mask is assembled with the light guiding plate by engaging the clasp and the slot.

9. The backlight module as claimed in claim 4, wherein the bending plate is formed by applying a punch-shaping process to a metallic sheet.

10. A liquid crystal device, comprising:
a backlight module, comprising:
a light guiding plate; and
a light source comprises a light body and a mask, the mask surrounds a rim of the light guiding plate to from a cavity with at least one opening, the light body is fixed on the opening and a light emitting surface of the light body faces toward an internal of the cavity.

11. The liquid crystal display as claimed in claim 10, wherein a reflective layer is arranged on an internal wall of the cavity.

12. The liquid crystal display as claimed in claim 11, wherein a plurality of reflective points are arranged on the reflective layers.

13. The liquid crystal display as claimed in claim 10, wherein the mask is a bending plate with U-shaped cross section, and the opening is arranged on two sides of the bending portions of the bending plate.

14. The liquid crystal display as claimed in claim 13, wherein the light body comprises printed circuit boards (PCBs) and LEDs encapsulated on the PCBs in a circular form so that light emitting surfaces of the LEDs are hemisphere.

15. The liquid crystal display as claimed in claim 14, the cavity comprises two openings, the light from the LEDs are toward the internal of the cavity, and are reflected from the internal wall of the cavity into the light guiding plate.

16. The liquid crystal display as claimed in claim 14, wherein at least one clasp is arranged on one edge of the bending plate.

17. The liquid crystal display as claimed in claim 16, wherein at least one slot is arranged on a side surface of the light guiding plate in accordance with the clasp so that the mask is assembled with the light guiding plate by engaging the clasp and the slot.

18. The liquid crystal display as claimed in claim 13, the bending plate is formed by applying a punch-shaping process to a metallic sheet.
